(19) United States
(12) Patent Application Publication
(10) Pub. No.: US 2025/0235722 A1
(43) Pub. Date: Jul. 24, 2025

(54) GAS-POWERED BREAKING TOOL

(71) Applicant: KBT, LLC, Burien, WA (US)

(72) Inventors: Douglas C. Hansen, SR., Burien, WA (US); Douglas C. Hansen, JR., Burien, WA (US); Paul Joseph Shemeta, Burien, WA (US)

(21) Appl. No.: 19/033,749

(22) Filed: Jan. 22, 2025

Related U.S. Application Data
(60) Provisional application No. 63/623,483, filed on Jan. 22, 2024.

(51) Int. Cl. A62B 3/00

(52) U.S. Cl. CPC A62B 3/005

(57) ABSTRACT

A gas-powered breaking tool includes a trigger, a firing mechanism actuated by the trigger, a chamber configured to hold a propulsion device, positioned such that the firing mechanism will strike the propulsion device to cause the propulsion device to fire, a piston located next to the chamber positioned such that gas from the propulsion device will cause the piston to move, a hinge positioned such that movement of the piston will cause the hinge to move forward, and a set of jaws comprising a lower jaw and an upper jaw and a gap between the lower jaw and the upper jaw, the lower jaw connected to the hinge and positioned to move forward and upward towards the upper jaw when the hinge moves forward to close the gap and act on any material in the gap.

### RELATED APPLICATIONS

This disclosure is a non-provisional of and claims benefit from U.S. Provisional Application No. 63/623,483, titled “GAS-POWERED TOOLS AND QUICK CONNECT CAPABILITY,” filed on Jan. 22, 2024, the disclosure of which is incorporated herein by reference in its entirety.

### TECHNICAL FIELD

This disclosure relates to various hand-held tools operated by the firing of a blank cartridge, more particularly to tools that break, cut and puncture upon firing of the cartridge.

### BACKGROUND

Hand-held, gas-powered tools for breaching doors and other structures generally involve a tool holdable in two hands that forces a ram to strike an object adjacent a gap, such as a doorknob, hinge, deadbolt, door lock, door plate, wall, etc., where the force results from gas power, such as gas discharged from the firing of a blank cartridge. The term “blank” means that the cartridge, similar to a shotgun shell or pistol or rifle cartridge, does not contain any projectiles. When the cartridge fires, the gas generated by the cartridge powers a central piston that drives the ram forward. U.S. Pat. No. 10,946,222, “Breaching Assist Tool,” issued Jan. 25, 2018, which is incorporated herein in its entirety.

It is possible to use the gas-powered back end of the tool for different types of front ends.

### BRIEF DESCRIPTION OF THE DRAWINGS

FIG. 1 shows a prior art embodiment of a gas-powered tool.

FIGS. 2 and 3 show an embodiment of a breaking tool.

FIGS. 4 and 5 show an embodiment of a penetrating tool.

FIG. 6 shows an embodiment of a cutting tool.

FIGS. 7 and 8 show an embodiment of a quick connect coupler.

### DETAILED DESCRIPTION OF THE EMBODIMENTS

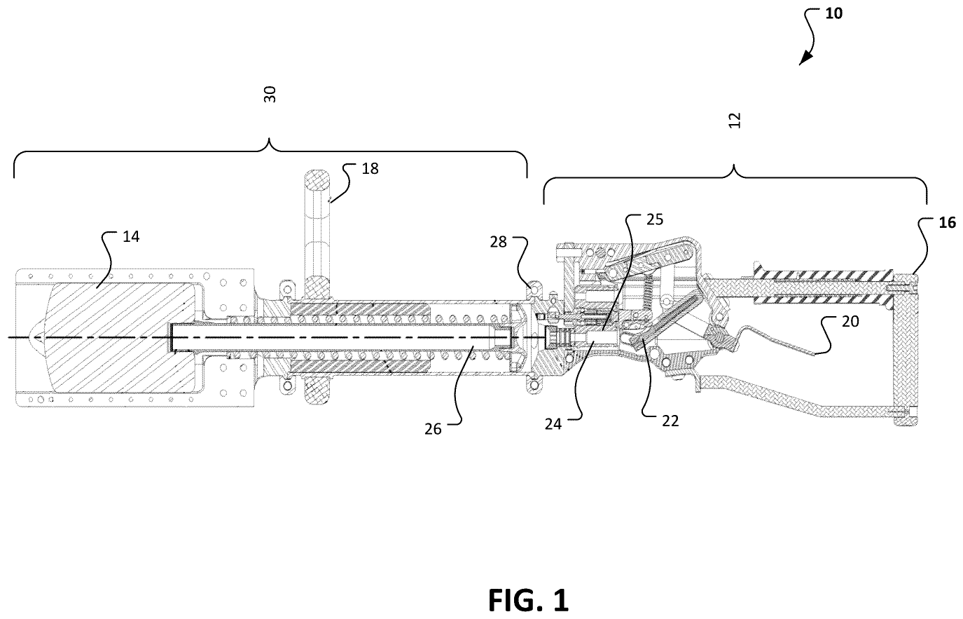

FIG. 1 shows a breaching assist tool 10 that has a gas-propulsion back end 12 that powers a sliding ram 14 to force the ram to break objects such as hinges, door latches, knobs, door plates, deadbolts, locks, walls, etc. to perform such actions as breaching a door. The tool is hand-held, made possible by the handles 16 and 18. When the user squeezes trigger 20 adjacent the handle 16, the firing mechanism 22 strikes the back end of a cartridge 24 located in chamber 25 to cause the cartridge to fire. The firing of the cartridge generates gas that causes the center piston 26 to move forward. The center piston in turn then causes the ram 14 to slam forward and into the targeted gap.

The chamber holding the center piston and the attached ram assembly connect to the gas propulsion back end of the tool by coupler 28. The back end 12 comprises trigger 20 and its assembly, rear handle 16, firing mechanism 22, and cartridge 24, essentially all parts of the device between the back of the device and the coupler 28. A user can use tools to disconnect the back end from the front end 30, in this case, the front-end assembly includes the center piston and attached ram assembly. This ability provides the possibility of attaching different front ends to the gas-powered back end. As discussed in more detail further, the front ends may attach to the back end in a fixed manner, or in a changeable manner.

One should note that gas propulsion may result from other propulsion devices than a blank firearm or other cartridge with a primer. These include compressed gas, like CO₂ cartridges or other compressed gases, fuel ignition, stored hydraulic energy, etc. No limitation to any one type of gas propulsion is intended and none should be implied.

One possible front end comprises a breaking tool. Breaking tools have multiple uses, not just for law enforcement and military applications, but for emergency services such as fire and rescue. Ideally, a breaking tool would be able to break or cut rebar, chain, and other components that can prevent fire and rescue workings, such as fire fighters, emergency medical personnel, etc., from reaching people in need of help.

By replacing the front end of the breaching tool with a breaking tool, the gas propulsion back-end, whether configured as the one above, or having a different configuration, can power a breaking tool. The term “breaking” tool encompasses many different configurations of a jaw portion of the tool, discussed in more detail below. The jaw may crush, snap, break, cut, etc. No limitation to any particular description of the action performed by the jaw is intended nor should any such limitation be implied.

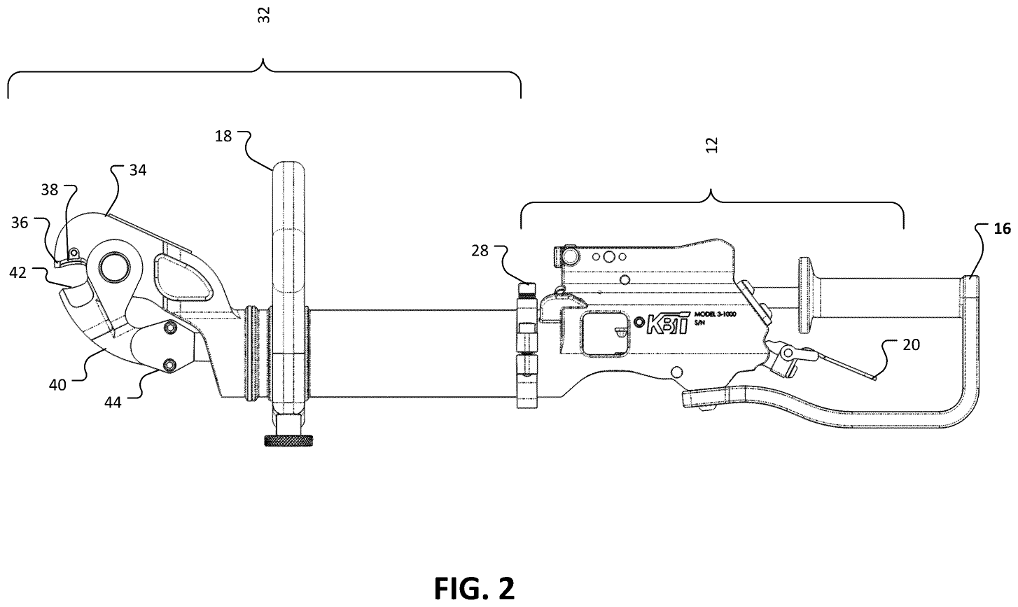

FIG. 2 shows a side view of and embodiment of a breaking tool, comprising the same back end 12, with a new front end 32. The new front end 32 has jaws 34, comprising a top jaw 36, with top jaw surface 38, lower jaw 40, and lower jaw surface 42. One or both of these surfaces may have different textures and shapes depending upon the desired application, such as having a texture, being sharpened, being coated, or covered such as with a material, including a piece of metal, etc. The lower jaw 40 closes the gap between the upper jaw and the lower jaw when the hinge portion 44 moves forward and slightly upward causing the lower jaw to rotate slightly and move upward. The center piston is positioned to move when a cartridge in the chamber fires, and the hinge is positioned to move when the center piston strikes or otherwise causes the hinge to move.

One should note that the terms “upper” and “lower” as used here refer to the orientation of the tool in the drawing. A user could also turn the tool sideways, in which case the jaws would have left jaws and right jaws. No limitation to any particular orientation is intended nor should any be implied. When the lower jaw closes the gap, any object in the gap will break, such as a link of chain, a lock shank, rebar, etc.

One should also note that the front ends of all the embodiments may all have the same size piston and assembly or may differ. The piston for the breaking tool may move upward within the chamber, but that may be within the tolerance of the chamber, and the piston itself may be the same as the piston used in the breaching tool. The common components may have the same dimension or may vary from one tool to the other.

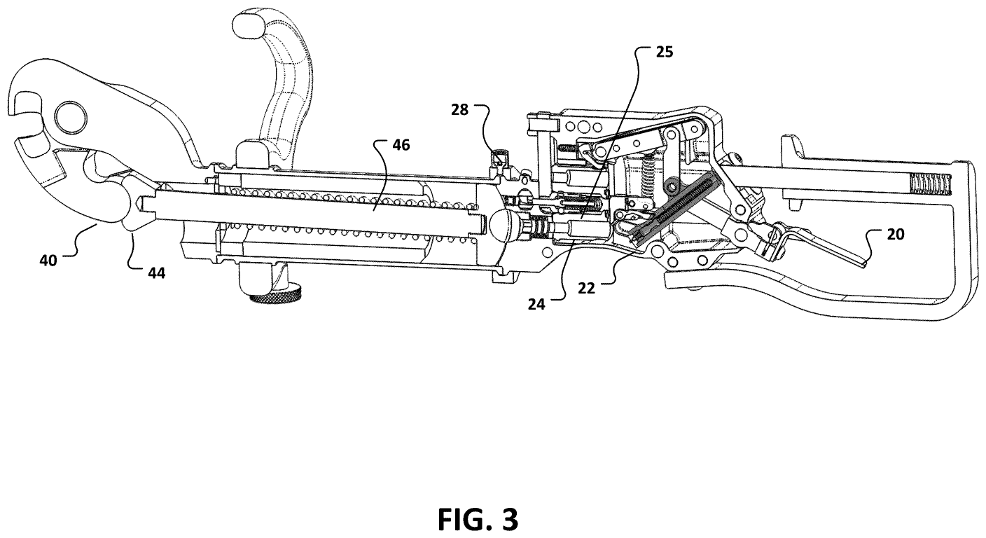

FIG. 3 shows a more detailed view of an embodiment of a breaking tool. The back end functions as previously discussed. When a user squeezes the trigger 20, the firing mechanism 22 strikes the cartridge 24 in chamber 25 causing the cartridge to fire. The pressure from the gas generated by the cartridge when fired causes the center piston 46 to move forward. As the center piston moves, the lower hinge portion 44 moves and rotates, causing the lower jaw 40 to move upward and close against the upper jaws, breaking whatever lies between the jaws. Experiments have shown that the breaking tool can break ⅝″ rebar, ½″ chain, and shanks for standard sized locks.

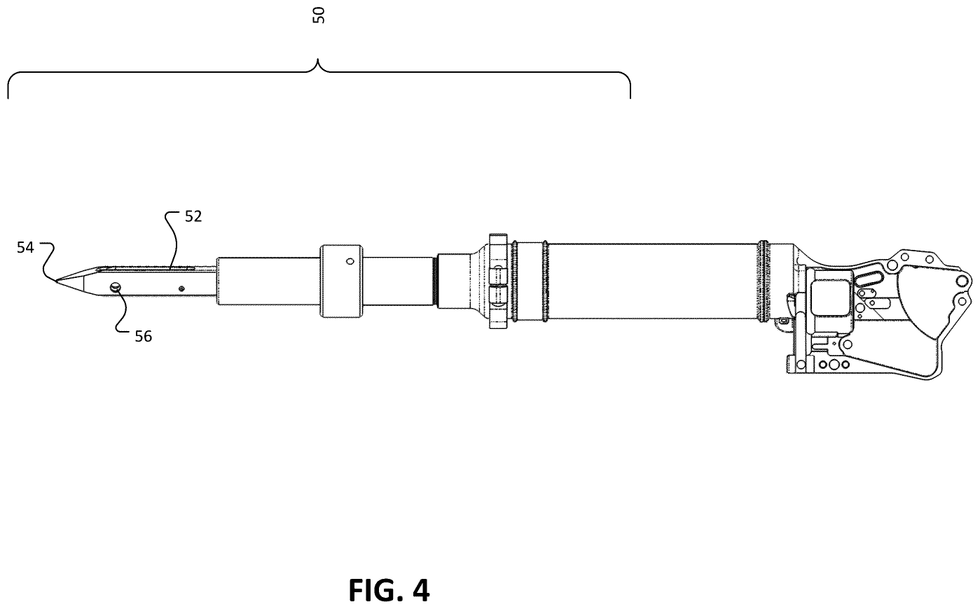

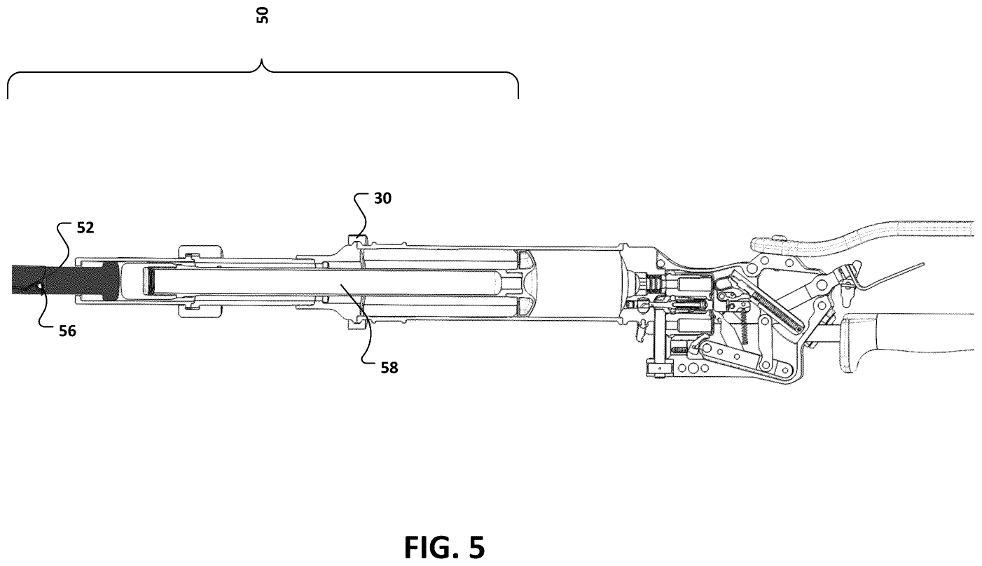

FIGS. 4 and 5 show another embodiment of a different front end, a glass penetrator. While useful for most glass, this front end 50 applies to bullet proof glass. For example, if a vehicle that has bullet proof glass has an accident, bullet proof glass can cause significant problems in extracting or even reaching the vehicle's occupants. Typically, the process removes the bullet proof glass pane completely if the rescuer can get some sort of grip or purchase on the pane. The removal generally occurs by a rope or chain attached to a motor or vehicle to pull the glass out of the vehicle frame.

In FIG. 4, the front end 50 has a penetrating portion 52 designed to penetrate bullet proof glass. The penetrating portion or “stinger” 52 has an end 54 with a point. Once the penetrating portion 52 punctures the glass, it remains inside the glass, the user can twist it and disconnect it from other portions of the front end and the back end. A rope or chain connects to the stinger to allow rescue personnel to then pull the bullet proof pane out of the frame using a vehicle or motor. Hole 56 allows the portion that deploys inside the glass once penetrated.

FIG. 5 shows a more detailed view of an embodiment of a penetrating front end. The user squeezes the trigger as in previous embodiments, causing the cartridge to fire and the gas pushes the center piston 58 to move forward striking the stinger end, causing the stinger to penetrate the bullet proof glass. The user can then twist the stinger to detach it from the other portions of the front end 50, which also causes the end to expand to remain inside the glass when the rope or chain is pulled to remove the panel.

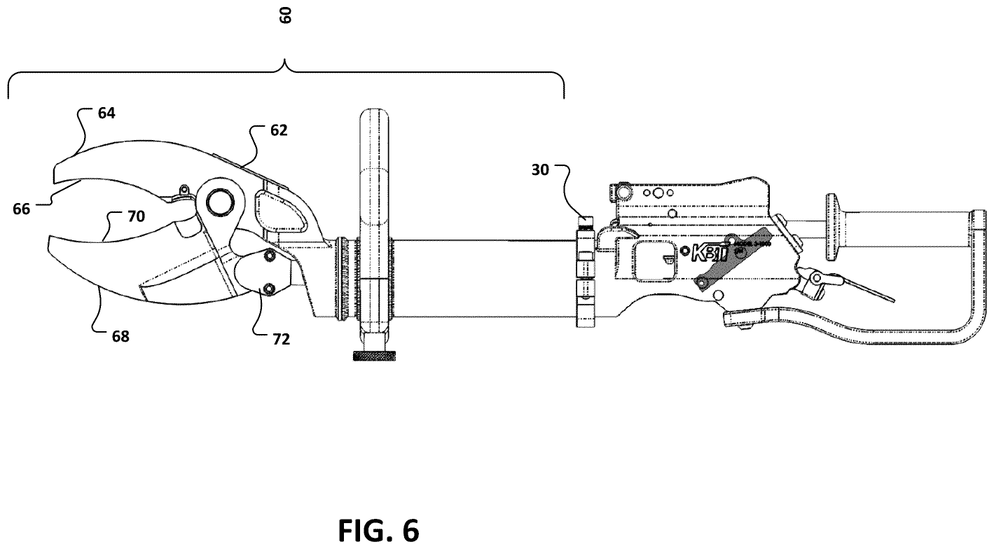

Another need involves cutting sheet metal. For both fire and rescue operations and law enforcement/military operations, the ability to cut sheet metal has many applications. FIG. 6 shows a front end 60 that includes metal shears or tin snips 62. The overall configuration of the shear tool has a similar structure to the breaking tool of FIGS. 2 and 3. The jaws of FIGS. 2 and 3 now take the form of shears. For purposes of this discussion, both the term “jaws” as used here encompasses any movable parts that move in response to pressure on a hinge portion, including the shears shown in FIG. 6.

The shears 62 have an upper shear 64 with a surface 66, and a lower shear 68, with a lower shear surface 70. One or both of the shear surfaces 66 and 70 could have a cutting edge, serrated teeth, have a coating or other metal cover, etc. Similar to the operation of the breaking tool, when the piston moves in response to the firing of the gas device, the hinge portion 72 will move, causing the lower shear 68 to move and cut whatever lies inside the shears. The front end of FIGS. 2 and 3 act on any material in the gap by breaking it, the shears of FIG. 6 act on the material by cutting it. As mentioned above, the front end of FIGS. 2 and 3 can also cut it depending upon the surfaces of the jaws of FIGS. 2 and 3. However, the shears are specifically configured to snip metal or other materials.

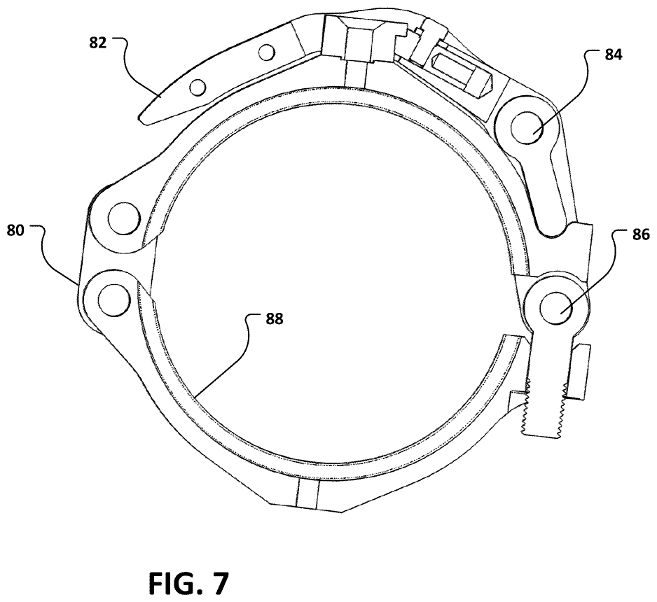

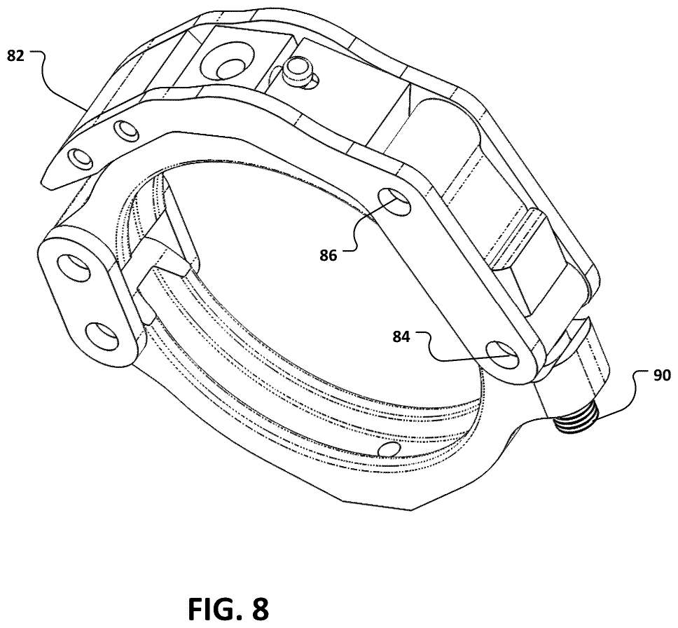

As mentioned above, these front ends, including the breaking tool front end of FIG. 1, can attach to the back end in a “fixed” or more permanent attachment. All the embodiments may use the same back end, although the possibility of using a different back end for each tool exists. However, in the situation where all the embodiments use the same back end, one could change the coupler 30 to be a quick connect/disconnect coupler. FIGS. 7 and 8 show an embodiment of such a quick connect coupler 80.

In FIG. 7, an embodiment of coupler 80 has a lever portion 82 that can lift and cause the coupler to rotate around pins such as 84 and 86. This causes the coupler to loosen and expand the inner diameter of the inside edges such as 88. The user can then remove the front end from the back end, replace the front end, push the lever portion towards the body of the coupler and solidly attach the front end to the back end.

As shown in FIG. 8, the coupler may include an adjustment screw 90 that can adjust the couple to make it more or less restricting to connect the front end more solidly to the back end of the tool. While many applications may prefer a fixed back end, meaning a more permanently attached back end, for some applications and environments, the modular approach of one back end to multiple front ends may have advantages. Some front ends, such as the bullet proof glass penetrator may insert into a sleeve on the back end, where the sleeve may also be attached to the back end by the coupler.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

The embodiments generally comprise a gas-powered back end that provides propulsion to different types of front ends, including a breaking tool, shears, and a bullet proof glass penetrator, as examples. The front end and back end could be connected in a quick-connect fashion allowing the back end to power multiple front ends, or they could be more permanently connected. Gas power may include, but is not limited to blank cartridges, compressed gas, like CO₂ cartridges or other compressed gases, fuel ignition, stored hydraulic energy, etc.

Although specific aspects of this disclosure have been illustrated and described for purposes of illustration, it will be understood that various modifications may be made without departing from the spirit and scope of the invention. Accordingly, the invention should not be limited except as set forth in the appended claims.

1. A gas-powered breaking tool, comprising:
a trigger;
a firing mechanism actuated by the trigger;
a chamber configured to hold a propulsion device, positioned such that the firing mechanism will strike the propulsion device to cause the propulsion device to fire;
a piston located next to the chamber positioned such that gas from the propulsion device will cause the piston to move;
a hinge positioned such that movement of the piston will cause the hinge to move forward; and
a set of jaws comprising a lower jaw and an upper jaw and a gap between the lower jaw and the upper jaw, the lower jaw connected to the hinge and positioned to move forward and upward towards the upper jaw when the hinge moves forward to close the gap and act on any material in the gap.

2. The gas-powered breaking tool as claimed in claim 1, wherein the upper jaw has an upper jaw surface, and the lower jaw has a lower jaw surface.

3. The gas-powered breaking tool as claimed in claim 2, wherein one or both of the upper jaw surface and the lower jaw surface are at least one of sharpened, textured, coated, or covered.

4. The gas-powered breaking tool as claimed in claim 1, wherein the propulsion device comprises one of a cartridge with a primer, a CO₂ cartridge, a fuel ignition device, or a device with stored hydraulic energy.

5. The gas-powered breaking tool as claimed in claim 1, wherein the set of jaws comprise shears.

6. The gas-powered breaking tool as claimed in claim 5, wherein the shears comprise an upper shear with an upper shear surface and a lower shear with a lower shear surface.

7. The gas-powered breaking tool as claimed in claim 6, wherein one or both of the upper shear surface and the lower shear surface comprise one of a cutting edge, serrated teeth, a coating, or a cover.

8. The gas-powered breaking tool as claimed in claim 1, wherein the trigger, the firing mechanism, and the chamber comprise a back end, and the piston, hinge and set of jaws comprise a removable front end.

9. A gas-powered breaking tool, comprising:
a gas-powered back end having a propulsion device;
a breaking tool having a piston, the breaking tool connected to the back end such that the piston is positioned to move in response to gas from the propulsion device;
the breaking tool having a hinge positioned such that movement of the piston will cause the hinge to move forward; and
the breaking tool having a set of jaws comprising a lower jaw and an upper jaw and a gap between the lower jaw and the upper jaw, the lower jaw connected to the hinge and positioned to move forward and upward towards the upper jaw when the hinge moves forward closing the gap and acting on any material in the gap.

10. The gas-powered breaking tool as claimed in claim 9, wherein the upper jaw has an upper jaw surface, and the lower jaw has a lower jaw surface.

11. The gas-powered breaking tool as claimed in claim 10, wherein one or both of the upper jaw surface and the lower jaw surface are at least one of sharpened, textured, coated, or covered.

12. The gas-powered breaking tool as claimed in claim 9, wherein the propulsion device comprises one of a cartridge with a primer, a CO₂ cartridge, a fuel ignition device, or a device with stored hydraulic energy.

13. The gas-powered breaking tool as claimed in claim 9, wherein the set of jaws comprise shears.

14. The gas-powered breaking tool as claimed in claim 13, wherein the shears comprise an upper shear with an upper shear surface and a lower shear with a lower shear surface.

15. The gas-powered breaking tool as claimed in claim 14, wherein one or both of the upper shear surface and the lower shear surface comprise one of a cutting edge, serrated teeth, a coating, or a cover.

16. The gas-powered breaking tool as claimed in claim 9, wherein the breaking tool is removable from gas-powered back end.
